(19) United States
(12) Patent Application Publication
(10) Pub. No.: US 2010/0167790 A1
(43) Pub. Date: Jul. 1, 2010

(54) Handheld Mobile Communication Apparatus and Operating Method Thereof

(75) Inventor: Kuan-Lun Su, Hsinchu Hsien (TW)

Correspondence Address: EDELL, SHAPIRO & FINNAN, LLC, 1901 RESEARCH BOULEVARD, SUITE 400, ROCKVILLE, MD, 20850, US

(73) Assignee: MStar Semiconductor, Inc., Hsinchu Hsien (TW)

(21) Appl. No.: 12/636,945

(22) Filed: Dec. 14, 2009

(30) Foreign Application Priority Data
Dec. 30, 2008 (TW) 097151460

(51) Int. Cl. G06F 3/041; H04B 1/40

(52) U.S. Cl. 455/566; 345/173

(57) ABSTRACT

A handheld mobile communication apparatus and operating method thereof are disclosed. The handheld mobile communication apparatus includes a touch sensing component, a key, a storage unit and a control unit. The touch sensing component senses a touch, thus generating a touch signal. The storage unit has a first command database and a second command database. The control unit selects the first command database or the second command database according to whether the key is pressed, and generates a control signal corresponding to the touch according to the touch signal and the selected command database.

### CROSS REFERENCE TO RELATED PATENT APPLICATION

This patent application is based on Taiwan, R.O.C. patent application No. 097151460 filed on Dec. 30, 2008.

### FIELD OF THE INVENTION

The present invention relates to a handheld mobile communication apparatus, and more particularly, to a handheld mobile communication apparatus integrated with a function key and a touch function, a handheld mobile communication apparatus and an operation method thereof.

### BACKGROUND OF THE INVENTION

As communication technology continues to develop, various types of handheld mobile communication apparatuses, having different functions, such as mobile phones, and personal digital assistants (PDAs), are increasingly becoming indispensable in the daily life of people. Of all the handheld mobile communication apparatuses, those having a touch function are particularly liked by consumers.

Generally, a current handheld mobile communication apparatus having a touch function employs a touch panel to provide a touch operation interface, and a user defines his operation via a touch or a moving track on the touch panel. However, this defining approach is always limited to defining simple operations such as a single touch, a continuous touch, an upward movement, a downward movement, a leftward movement, a rightward movement, and so on, thus influencing the versatility in operating the handheld mobile communication apparatus.

Although a multi-touch approach is presently adopted to provide more different operation definitions, the multi-touch approach needs a touch panel capable of supporting capacitance technology, which means it is impossible to implement the multi-touch approach on a common touch panel that operates using the resistance technology. In addition, a capacitance touch panel is much more expensive than a resistance touch panel such that an overall production cost of a handheld mobile communication apparatus is increased and market competitiveness of the handheld electronic is undesirably influenced.

In a handheld mobile communication apparatus, more complicated actions or operations may be defined via different sliding movements from a finger on a touch panel; however, the amount of data to be stored and computed by the handheld mobile communication apparatus would also increase drastically. Moreover, due to excessively complicated moving patterns and operations, not only may the handheld mobile communication apparatus become too hard to manipulate, but the failure probability of identifying a moving operation by the handheld mobile communication apparatus may also increase.

Therefore, a main scope of the present invention is to provide a handheld mobile communication apparatus, a handheld mobile communication apparatus and an operating method thereof in order to solve the foregoing problems.

### SUMMARY OF THE INVENTION

A handheld mobile communication apparatus is provided according to a first embodiment of the present invention. For example, the handheld mobile communication apparatus is a mobile phone or a satellite navigation device; however, these examples shall not be construed as limiting the present invention. In this embodiment, the handheld mobile communication apparatus comprises a touch sensing component, a key, a storage unit and a control unit. The control unit is coupled to the touch sensing component, the key and the storage unit. The storage unit stores a first command database and a second command database.

Upon sensing a touch, the touch sensing component generates a touch signal. The control unit selects the first command database or the second command database according to whether the key is pressed, and generates a control signal corresponding to the touch according to the touch signal and the selected command database.

A method for operating a handheld mobile communication apparatus is provided according to a second embodiment of the present invention. In this embodiment, the handheld mobile communication apparatus comprises a touch sensing component, a key, and a storage unit storing a first command database and a second command database. The method comprises generating a touch signal in response to a touch sensed by the touch sensing component, selecting the first command database or the second command database according to whether the key is pressed, and generating a control signal corresponding to the touch according to the touch signal and the selected database.

In conclusion, without increasing user operation complexity, a handheld mobile communication apparatus and an operating method thereof according to the embodiments of the present invention are capable of increasing selectivity of types of a touch panel or a touch pad and providing diversified operation defining approaches by integrating a key of a mobile phone with the touch panel or the touch pad. In addition, the handheld mobile communication apparatus according to an embodiment of the present invention may be implemented with a less expensive resistance touch panel to avoid using the more expensive capacitance touch panel, thus effectively reducing the production cost and increasing the market competitiveness.

The advantages and spirit related to the present invention can be further understood via the following detailed description and drawings.

### BRIEF DESCRIPTION OF THE DRAWINGS

FIG. 1 is a block diagram of a handheld mobile communication apparatus in accordance with a first embodiment of the present invention.

FIG. 2 shows an example of a handheld mobile communication apparatus.

FIG. 3 is a flowchart of a method for operating a handheld mobile communication apparatus in accordance with a second embodiment of the present invention.

FIG. 4 to FIG. 6 respectively show flowcharts of various possible practical operation situations of a handheld mobile communication apparatus.

### DETAILED DESCRIPTION OF THE PREFERRED EMBODIMENT

A main object of the present invention is to provide a handheld mobile communication apparatus, and an operating method thereof. According to the present invention, a key of a handheld mobile communication apparatus or a handheld mobile communication apparatus is integrated with a touch panel or a touch pad to provide more diversified operation approaches as well as simple operations, thereby bringing a user enhanced operation convenience.

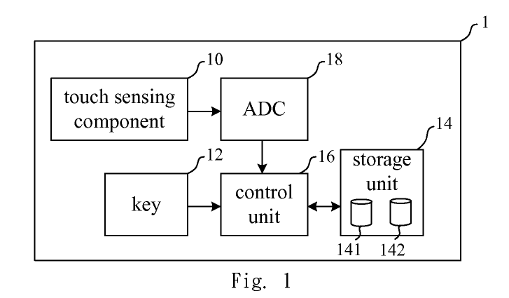

A handheld mobile communication apparatus is provided according to a first embodiment of the present invention. For example, the handheld mobile communication apparatus is a mobile phone or a satellite navigation apparatus; however, these examples shall not be construed as limiting the present invention. FIG. 1 shows a block diagram of a handheld mobile communication apparatus.

A handheld mobile communication apparatus 1 comprises a touch sensing component 10, a key 12, a storage unit 14, a control unit 16 and an analog-to-digital converter (ADC) 18. The touch sensing component 10 is coupled to the control unit 16 via the ADC 18. The key 12 and the storage unit 14 are respectively coupled to the control unit 16. The storage unit 14 stores a first command database 141 and a second command database 142, which respectively comprise a plurality of function commands. The handheld mobile communication apparatus 1 performs an operation corresponding to each of the function commands. A corresponding relationship between the function commands and the operations of the handheld mobile communication apparatus 1 may be predetermined or user-defined.

For example, through the touch sensing component 10, the user may perform operations such as zooming in or zooming out an image or window, moving a cursor, scrolling a page, or selecting an object on the handheld mobile communication apparatus 1.

In this embodiment, the touch sensing component 10 may be a touch panel or a touch pad, which is placed on any surface of the handheld mobile communication apparatus 1, and an area size occupied by the touch sensing component is unrestricted. The storage unit 14 may be any type of memory or memory card. The key 12 may be a function key and may be placed on any surface of the handheld mobile communication apparatus 1. However in a practical application, to ensure easy operations for the user in a way that the user is allowed to press the key 12 with a hand holding the handheld mobile communication apparatus 1 and touch the touch sensing component with the other hand, the touch sensing component 10 and the key 12 are preferably placed on a front and a side of the handheld mobile communication apparatus 1, respectively; however, the present invention is not limited to this example.

When the touch sensing component 10 is touched and operated by the user, the touch is sensed by the touch sensing component 10 and a touch signal is generated. Generally, since the touch signal generated by the touch sensing component 10 is an analog signal, the touch signal in the analog format first needs to be processed and converted to a digital format by the ADC 18, and the digital touch signal is then to be processed by the control unit 16.

The control unit 16 selects the first command database 141 or the second command database 142 from the storage unit 14 according to whether the key 12 is pressed, and generates a control signal according to the touch signal in the digital format and the selected command database. For example, the first command database 141 is a predetermined command database; that is, when the key 12 is not pressed, the touch unit 16 selects the first command database 141 from the storage unit 14, and when the key 12 is pressed, the touch unit 16 selects the second command database 141 from the storage unit 14. In addition, a same touch signal corresponds to different control signals in the first command database 141 or the second command database 142; that is, when the control unit 16 selects different command databases even based on a same touch signal generated, different control signals corresponding to different operations of the handheld mobile communication apparatus 1 are generated.

It is to be noted that, in the handheld mobile communication apparatus 1, the key 12 is applied to two different situations. The first situation is that the key 12 is especially built to integrate with a touch function of the handheld mobile communication apparatus 1. In this situation, an operation of the handheld mobile communication apparatus 1 is similar to that of the foregoing description.

In another situation, the key 12 is originally on the handheld mobile communication apparatus 1 and has a predetermined function, and there is more than one function corresponding to operations of the key 12. In order to accurately identify a function, which is to be correspondingly performed from pressing the key 12, the control unit 16 further determines whether duration of the key being pressed is greater than a threshold. For example, the threshold is a predetermined value of the handheld mobile communication apparatus 1 or a use-defined value according to habits or preferences of the user.

In this embodiment, suppose that the first command database 141 is a predetermined command database of the handheld mobile communication apparatus 1. When the result generated by the control unit 16 is no, i.e., when the duration of a press of the key 12 is not greater than the threshold, the control unit 16 performs a predetermined function of the key 12, and at this point the selected command database is still the first command database 41. When the result generated by the control unit 16 is yes, i.e., when the duration of the press of the key 12 is greater than the threshold, the control unit 16 selects the non-predetermined second command database 142, and the predetermined function of the key 12 is not performed.

For example, when the user wishes to browse photos through a touch function of a mobile phone, a previous image or a next image is switched to by sliding leftward or rightward on a touch sensing component. However, it is rather troublesome to perform the sliding on the touch panel each time the user wishes to browse the previous image or the next image. The handheld mobile communication apparatus 1 according to an embodiment of the present invention is capable of effectively solving such drawback—a practical application example shall be described below.

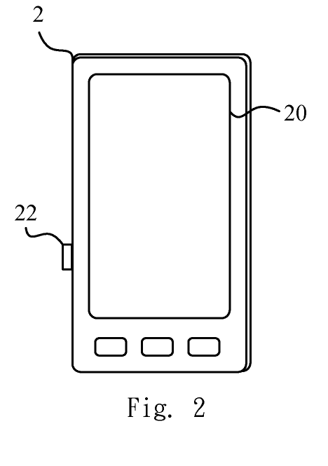

Referring to FIG. 2, suppose that the handheld mobile communication apparatus 1 is a mobile phone 2 comprising a touch sensing component 20 and a key 22, and the touch sensing component 20 is a touch panel or a touch pad. In this embodiment, the key 22 is especially designed as being integrated with a touch function. When browsing through photos, as the key 22 is not pressed and the touch sensing component 22 senses a leftward or rightward motion, the mobile phone 2 switches to a previous photo or a next photo; as the key is pressed and the touch sensing component senses a leftward or rightward motion, the mobile phone 3 performs a function of continual forward or backward photo browsing.

In another embodiment, the key 22 is a volume adjusting key originally placed on a left side of the mobile phone 2, and is given a function integrated with the touch function in order to cooperate with operations of the touch sensing component 20. Since a press of the key 22 corresponds to more than one function, duration of pressing the key 22 is used for distinguishing the function corresponding to the touch of the key 22.

When the duration of pressing the volume adjusting key by the user is less than a threshold of 1.5 seconds, it means that the user wishes to adjust the volume of the mobile phone 2, which shall correspondingly perform a function of adjusting the volume. When the duration of pressing the volume adjusting key by the user is longer than 1.5 seconds, it means that the mobile phone 2 is prompted into a touch mode, in which the user may then slide a finger on the touch sensing component 20 to command the mobile phone 2 to perform a corresponding function. Therefore, when the user holds the mobile phone 2 with his left hand and presses the volume adjusting key for more than 1.5 second, the mobile phone 2 enters the touch mode, and the user creates a leftward or a rightward motion on the touch panel with his right hand to continually browse forward or backward through images. In a photo browsing mode, when the key 22 is not pressed and the user performs a same motion, the mobile phone 2 switches to a previous or next photo.

As mentioned above, a same operation motion of a user may correspond to different control signals in different command databases; that is, different operations are performed on the mobile phone 2 or the handheld mobile communication apparatus 1. Therefore, according to the present invention, by co-operating a touch sensing component (e.g., a touch panel or a touch pad) with a key (whether originally available or additionally provided), an effect of generating different operation commands via a same operation motion (e.g., clicking or sliding) is achieved.

It is to be noted that, the foregoing description takes a function of photo browsing via a mobile phone for illustration purposes; however, in a practical application, other functions may be generated by integrating a function key with a touch function. For example, the function is zooming in or out photos, moving a cursor, scrolling a page, clicking an object, and so on.

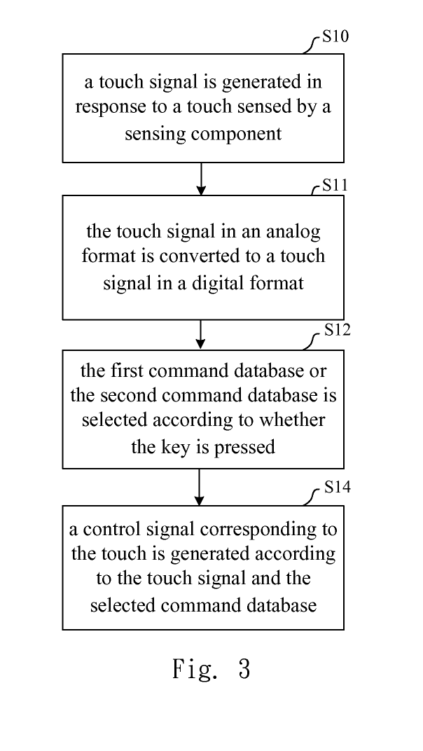

A method for operating a handheld mobile communication apparatus is provided according to a second embodiment of the present invention. In this embodiment, the handheld mobile communication apparatus comprises a touch sensing component, a key, and a storage unit storing a first command database and a second command database. For example, the handheld mobile communication apparatus is a mobile communication apparatus such as a mobile phone or a satellite navigation apparatus. The touch sensing component is a touch panel or a touch pad. However, the present invention is not limited to the examples given above. FIG. 3 shows a flowchart of a method for operating the handheld mobile communication apparatus.

In Step S10, a touch signal is generated in response to a touch sensed by the sensing component. In Step S12, the first command database or the second command database is selected according to whether the key is pressed. After that, in Step S14, a control signal corresponding to the touch is generated according to the touch signal and the selected command database.

For example, the touch signal generated in Step S10 is an analog signal, and thus Step S11 is performed before Step S12. In Step 11, the touch signal in an analog format is converted to a touch signal in a digital format. In addition, the touch signal in the first command database or the second command database respectively corresponds to different control signals.

The foregoing steps are designed with respect to the key being integrated with the touch function; however, the key may be a function key having a predetermined function. In order to identify an intended function corresponding to the touch of the user, a step of determining duration of a press on the key is performed. When the duration is not greater than a threshold, the predetermined function is performed, and at this point the selected command database is a predetermined command database such as the first command database. When the duration is greater than the threshold, the second command database is selected.

In the following description, several practical operation situations of a handheld mobile communication apparatus having a first command database serving as a predetermined command database shall be discussed.

Suppose that a function key of the handheld mobile communication apparatus is especially designed to be integrated and only to be applied in conjunction with a touch function. That is, the function key does not correspond to other predetermined functions. The handheld mobile communication apparatus first determines whether the function key is pressed and then identifies a touch motion of a finger on a touch sensing component; alternatively, the handheld mobile communication apparatus first identifies a touch motion of a finger on a touch sensing component and then determines whether the function key is pressed.

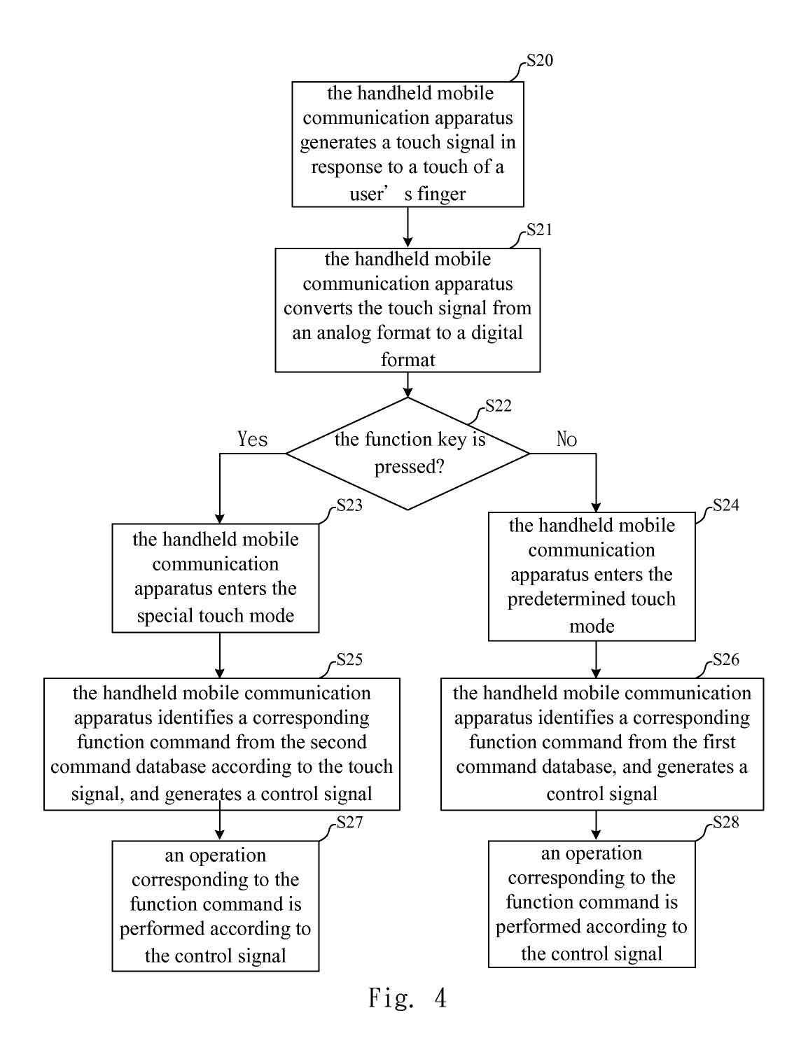

FIG. 4 shows a flowchart of first sensing a touch of a touch sensing component and then determining whether a function key is pressed by a handheld mobile communication apparatus. In Step S20, when a user touches the touch sensing component of the handheld mobile communication apparatus with his finger, the handheld mobile communication apparatus generates a touch signal. In Step S21, since the touch signal is an analog signal, the handheld mobile communication apparatus converts the touch signal from an analog format to a digital format. In Step S22, the handheld mobile communication apparatus determines whether the function key is pressed.

In Step S23, when the result of Step S22 is yes, it means that the user wishes to use a special touch mode in which a touch function key is integrated with a touch function, and the handheld mobile communication apparatus enters the special touch mode. In this mode, a second command database is selected. In Step S25, the handheld mobile communication apparatus identifies a corresponding function command from the second command database according to the touch signal, and generates a control signal. In Step S27, an operation corresponding to the function command is performed according to the control signal.

When the result of Step S22 is no, it means that the user selects a predetermined touch mode. In Step S24, in this mode, the selected command database is a predetermined first command database, and the handheld mobile communication apparatus enters the predetermined touch mode. In Step S26, the handheld mobile communication apparatus identifies a corresponding function command from the first command database, and generates a control signal. In Step S28, an operation corresponding to the function command is performed according to the control signal.

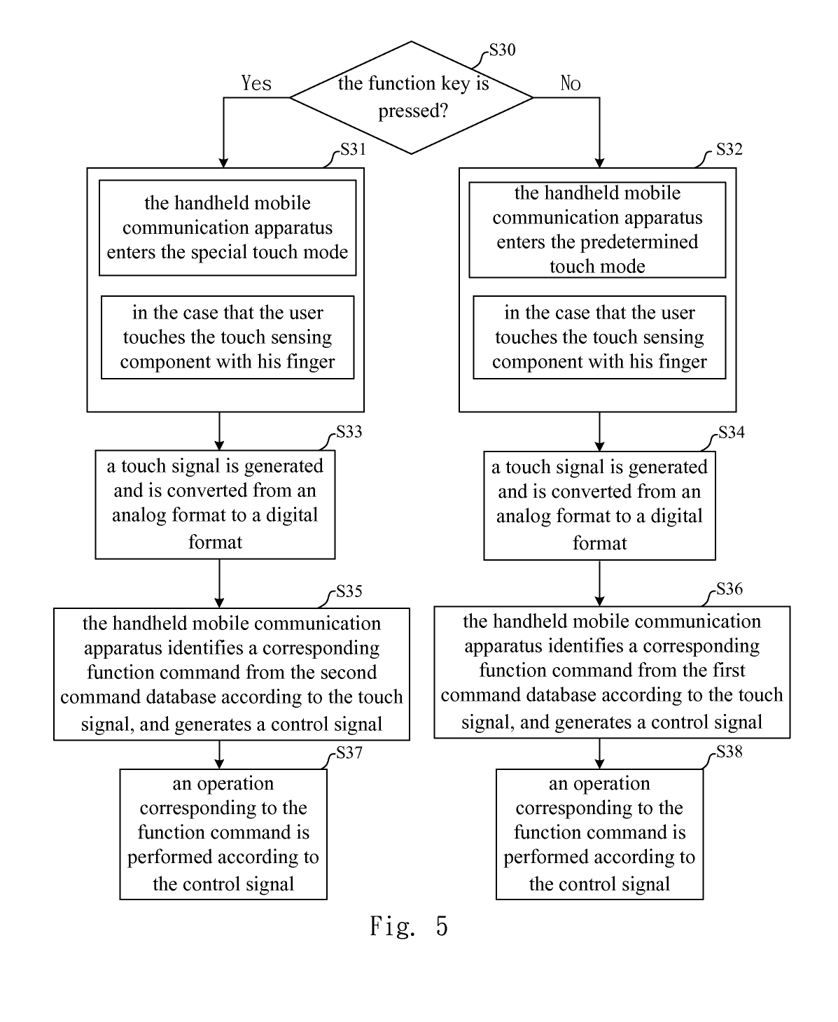

FIG. 5 shows a flowchart of first determining whether a function key is pressed by a handheld mobile communication apparatus and then sensing a touch of a touch sensing component with a finger. In Step S30, the handheld mobile communication apparatus first determines whether the function key is pressed. In Step S31, when the result of Step S30 is yes, it means that the user wishes to use a special touch mode in which a touch function key is integrated with a touch function, and the handheld mobile communication apparatus enters the special touch mode. In this mode, the selected command database is the second command database. In Step S33, when the user touches the touch sensing component with his finger, a touch signal is generated and is converted from an analog format to a digital format. In Step S35, the handheld mobile communication apparatus identifies a corresponding function command from the second command database, and generates a control signal. In Step S37, an operation corresponding to the function command is performed according to the control signal.

When the result of Step S30 is no, it means that the user selects a predetermined touch mode. In Step S32, the handheld mobile communication apparatus enters the predetermined touch mode, and in this mode, the selected command database is a predetermined first command database. In Step S34, when the user touches the touch sensing component with his finger, a touch signal is generated and is converted from an analog format to a digital format. In Step S36, the handheld mobile communication apparatus identifies a corresponding function command from the first command database, and generates a control signal. In Step S38, an operation corresponding to the function command is performed according to the control signal.

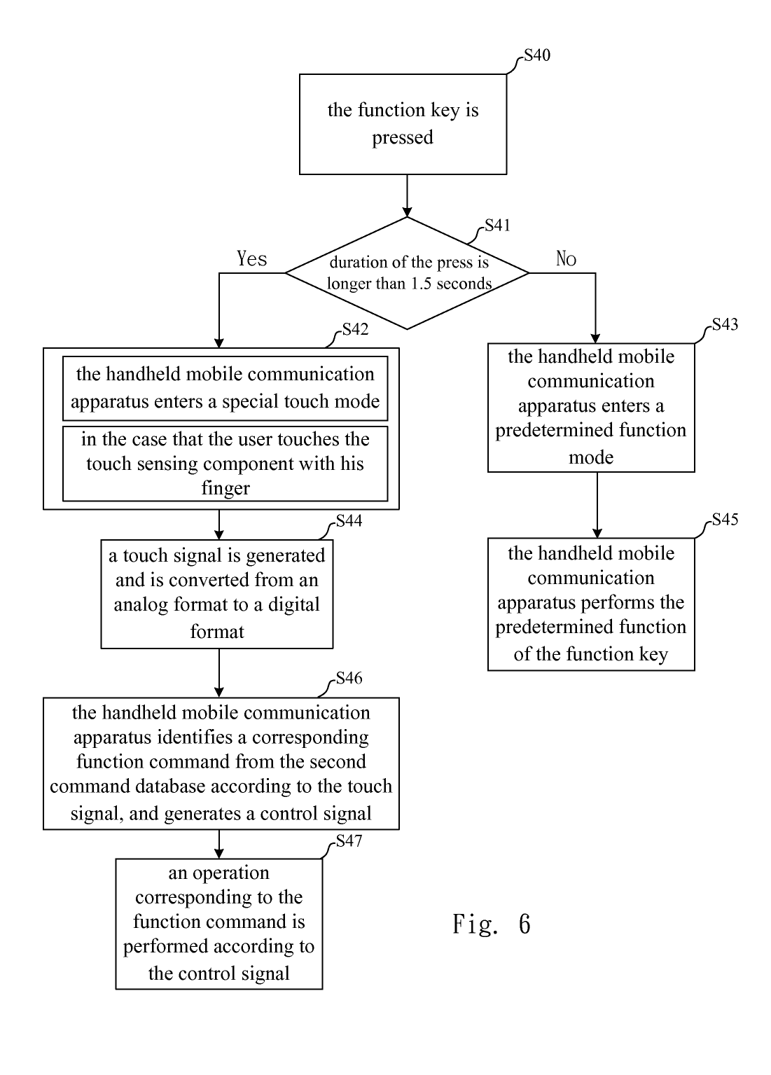

Suppose that a function key is an existing key of a handheld mobile communication apparatus and is corresponding to a predetermined function. FIG. 6 shows a flowchart of an operating situation of the handheld mobile communication apparatus. In Step S40, the function key is pressed. In Step S41, the handheld mobile communication apparatus determines whether duration of the press is longer than 1.5 seconds, which is a threshold for determining whether it is a long press or a short press of the function key; however, the present invention is not limited to this example.

In Step S42, when the result of Step S41 is yes, the handheld mobile communication apparatus enters a special touch mode. In this mode, the second command database is selected. In Step S44, when the user touches the touch sensing component with his finger, a touch signal is generated and is converted from an analog format to a digital format. In Step S46, the handheld mobile communication apparatus identifies a corresponding function command from the second command database, and generates a control signal. In Step S47, an operation corresponding to the function command is performed according to the control signal.

In Step S43, when the result of Step S41 is no, it means that the user selects a predetermined function of the function key, so that the handheld mobile communication apparatus enters a predetermined function mode. In this mode, the selected command database is a predetermined first command database. In Step S45, the handheld mobile communication apparatus performs the predetermined function of the function key, such as volume adjusting. When the touch sensing component senses a touch, the handheld mobile communication apparatus identifies a corresponding function command from the first command database, generates a control signal, and performs an operation corresponding to the function command according to the control signal.

In conclusion, without increasing user operation complexity, a handheld mobile communication apparatus and an operating method thereof according to an embodiment of the present invention are capable of increasing selectivity of types of a touch panel or a touch pad and providing diversified operation defining approaches to the user by integrating a key of a mobile phone with the touch panel or the touch pad. In addition, the handheld mobile communication apparatus according to an embodiment of the present invention may be implemented with a less expensive resistance touch panel to avoid using the more expensive capacitance touch panel, thus effectively reducing the production cost and increasing the market competitiveness.

While the invention has been described in terms of what is presently considered to be the most practical and preferred embodiments, it is to be understood that the invention needs not to be limited to the above embodiments. On the contrary, it is intended to cover various modifications and similar arrangements included within the spirit and scope of the appended claims which are to be accorded with the broadest interpretation so as to encompass all such modifications and similar structures.

What is claimed is:

1. A handheld mobile communication apparatus, comprising:
a touch sensing component, for sensing a touch to generate a touch signal;
a key;
a storage unit, for storing a first command database and a second command database; and
a control unit, coupled to the touch sensing component, the key and the storage unit, for selecting the first command database or the second command database according to whether the key is pressed, and generating a control signal according to the touch signal and the selected command database.

2. The handheld mobile communication apparatus as claimed in claim 1, wherein the touch sensing component is a touch panel.

3. The handheld mobile communication apparatus as claimed in claim 1, wherein the touch sensing component is a touch pad.

4. The handheld mobile communication apparatus as claimed in claim 1, the touch signal being an analog signal, the handheld mobile communication apparatus further comprising:
an analog-to-digital converter (ADC), coupled to the touch sensing component and the control unit, for converting the touch signal in an analog format to a touch signal in a digital format to generate a digital touch signal, and transmitting the digital touch signal to the control signal.

5. The handheld mobile communication apparatus as claimed in claim 1, wherein the key has a predetermined function, and the control unit further determines duration of a press of the key and performs the predetermined function when the duration is not greater than a threshold.

6. The handheld mobile communication apparatus as claimed in claim 5, wherein the first command database is a predetermined command database, and the control unit selects the second command database when it is determined that the duration is greater than the threshold.

7. A method for operating a handheld mobile communication apparatus comprising a touch sensing component, a key, and a storage unit storing a first command database and a second command database, the method comprising:
generating a touch signal in response to a touch sensed by the touch sensing component;
selecting, as a selected command database, the first command database or the second command database according to whether the key is pressed; and
generating a control signal according to the touch signal and the selected command database.

8. The method as claimed in claim 7, wherein the touch sensing component is a touch panel.

9. The method as claimed in claim 7, wherein the touch sensing component is a touch pad.

10. The method as claimed in claim 7, the touch signal being an analog signal, the method further comprising:
converting the touch signal from an analog format to a digital format.

11. The method as claimed in claim 7, the key having a predetermined function, the method further comprising:
determining duration of a press of the key, and performing the predetermined function when the duration is not greater than a threshold.

12. The method as claimed in claim 11, the first command database being a predetermined command database, the method further comprising:
selecting the second command database when the duration is greater than the threshold.

13. The method as claimed in claim 7, wherein the touch signal respectively corresponds to different control signals in the first command database and the second command database.

14. A handheld mobile communication apparatus, comprising:
a touch unit, for sensing a touch when the touch is generated on the touch unit by an object to generate a touch signal;
a key, for generating a switch signal when the key is pressed; and
a control unit, coupled to the touch unit and the key, for determining whether the switch signal is generated when the touch signal is generated; and generating a first control signal corresponding to the touch signal when the switch signal is not generated and generating a second control signal corresponding to the touch signal when the switch signal is generated;
wherein, the handheld mobile communication apparatus performs different operations corresponding to the first control signal and the second control signal.

15. The handheld mobile communication apparatus as claimed in claim 14, further comprising:
a storage unit, coupled to the control unit, for storing a first command database and a second command database;
wherein, the control unit selects the first command database or the second command database according to whether the switch signal is generated to correspondingly generate the first control signal or the second control signal.

16. The handheld mobile communication apparatus as claimed in claim 14, wherein the touch unit is a touch panel.

17. The handheld mobile communication apparatus as claimed in claim 14, wherein the touch unit is a touch pad.

18. The handheld mobile communication apparatus as claimed in claim 14, the touch signal being an analog signal, the handheld mobile communication apparatus further comprising:
an ADC, coupled to the touch unit and the control unit, for converting the touch signal in the analog format to a touch signal in a digital format to generate a digital touch signal, and transmitting the digital touch signal to the control signal.

19. The handheld mobile communication apparatus as claimed in claim 14, wherein the key has a predetermined function, and the control unit further determines duration of a press of the key and performs the predetermined function when the duration is not greater than a threshold.

20. The handheld mobile communication apparatus as claimed in claim 19, wherein the first command database is a predetermined command database, and the control unit selects the second command database when it is determined that the duration is greater than the threshold.
